(19) United States
(12) Patent Application Publication
(10) Pub. No.: US 2026/0268577 A1
(43) Pub. Date: Sep. 10, 2026

(54) COMPUTATIONAL LOAD BALANCING FOR 3D VIRTUAL ENVIRONMENTS

(71) Applicant: thinAir Technologies, Inc., Covington, LA (US)

(72) Inventor: Jeremey Charbonnet, Covington, LA (US)

(21) Appl. No.: 19/555,319

(22) Filed: Mar. 3, 2026

Related U.S. Application Data
(60) Provisional application No. 63/767,879, filed on Mar. 6, 2025.

(51) Int. Cl. G06T 15/00; G06T 15/20; G06T 15/80

(52) U.S. Cl. CPC G06T 15/005; G06T 15/20; G06T 15/80

(57) ABSTRACT

Determining a point-of-view (POV) of a 2D plane representing a 3D virtual object in a virtual environment. Applying a shading pattern to the 2D plane based on the POV in order to make the 2D plane appear as a 3D version of the 3D virtual object from the POV. Obtaining contextual data that indicates a context of the device or a user of the device. The contextual data indicates a user interaction level with the 2D plane representing the 3D virtual object and a current computational load of the device. Replacing the 2D plane representing the 3D virtual object with the 3D virtual object based on the current computational load of the device and a change in the user interaction level with the 2D plane.

### CROSS-REFERENCE TO RELATED APPLICATIONS

This application claims priority to U.S. Provisional Patent App. No. 63/767,879, filed on March 6, 2025, which is hereby incorporated by reference in its entirety.

### TECHNICAL FIELD

The present disclosure generally relates to computational load balancing for 3D virtual environments.

### BACKGROUND

Some devices include a display. Some devices display virtual objects on the display. Displaying virtual objects can be resource-intensive. For example, rendering virtual objects in three dimensions (3D) is power-intensive. As such, rendering virtual objects in 3D can drain a battery of a battery-operated device and cause excessive heating in a portable electronic device.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1E are diagrams of an example environment in accordance with some implementations.

FIG. 2 is a block diagram of a system that performs load balancing in accordance with some implementations.

FIG. 3 is a flowchart representation of a method of balancing computational load in accordance with some implementations.

FIG. 4 is a block diagram of a device that implements load balancing in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for balancing computational load in presenting 3D virtual environments. In some implementations, a device includes a display, an input device, one or more processors and a non-transitory memory. In various implementations, a method includes determining a first point-of-view (POV) of a two-dimensional (2D) plane representing a three-dimensional (3D) virtual object from a user location characterized by a set of coordinates in a virtual environment and a distance between the user location and a location corresponding to the 3D virtual object. In some implementations, the method includes applying a first shading pattern to the 2D plane based on the first POV in order to make the 2D plane appear as a 3D version of the 3D virtual object from the first POV. In some implementations, the method includes obtaining contextual data that indicates a context of the device or a user of the device. The contextual data indicates a user interaction level with the 2D plane representing the 3D virtual object and a current computational load of the device. In some implementations, the method includes replacing the 2D plane representing the 3D virtual object with the 3D virtual object based on a combination of the current computational load of the device and a change in the user interaction level with the 2D plane representing the 3D virtual object.

In accordance with some implementations, a device includes one or more processors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Volumetric virtual objects are resource intensive to render continuously. As a result, as a number of volumetric virtual objects in a scene increases the frame rate typically has to drop to accommodate increasing numbers of volumetric virtual objects. Decreasing the frame rate adversely impacts a user experience provided by the device. Furthermore, continuously utilizing a renderer to render virtual objects in three dimensions (3D) increases a utilization of computing resources thereby contributing to a computational overload of the device. Increased utilization of computing resources drains a battery of a battery-operated device. Moreover, continuously utilizing the renderer to render virtual objects in 3D tends to result in overheating of the device. The overheating is exacerbated for portable electronic devices with limited heat dissipation capabilities, in particular for wearable electronic devices such as a head-mountable device (HMD) which becomes unusable in a safe manner when overly-hot.

The present disclosure provides methods, systems, and/or devices for balancing a computational load of the device while displaying virtual objects. Instead of always rendering a virtual object in 3D, a device sometimes displays a two-dimensional (2D) plane that represents the 3D virtual object. The device applies a suitable shading pattern to the 2D plane in order make the 2D plane look similar to the 3D virtual object that the 2D plane represents. The device monitors a level of user interaction with the 2D plane representing the 3D virtual object. When the level of user interaction exceeds a threshold level of interaction, the device replaces the 2D plane with the 3D virtual object. The device also monitors a computational load of the device and switches between displaying the 2D plane and the 3D virtual object based on the computational load of the device and the user interaction level with the virtual object. Switching between displaying the 2D plane and the 3D virtual object allows the device to balance the computational load of the device while still providing an acceptable user experience. Since dynamically shading the 2D plane has a lower computational overload than rendering the 3D virtual object, displaying the 2D plane uses less power than 3D rendering of the virtual object. As such, selectively switching between displaying the 2D plane and the 3D virtual object based on the user interaction level and the computational load extends a battery life of a battery-operated device. Furthermore, since dynamically shading the 2D plane uses less graphics processing resources than 3D rendering, displaying a dynamically-shaded 2D plane results in less heat generation which allows the user of an HMD to use the HMD in a safe manner for a prolonged period of time thereby improving a functionality of the device.

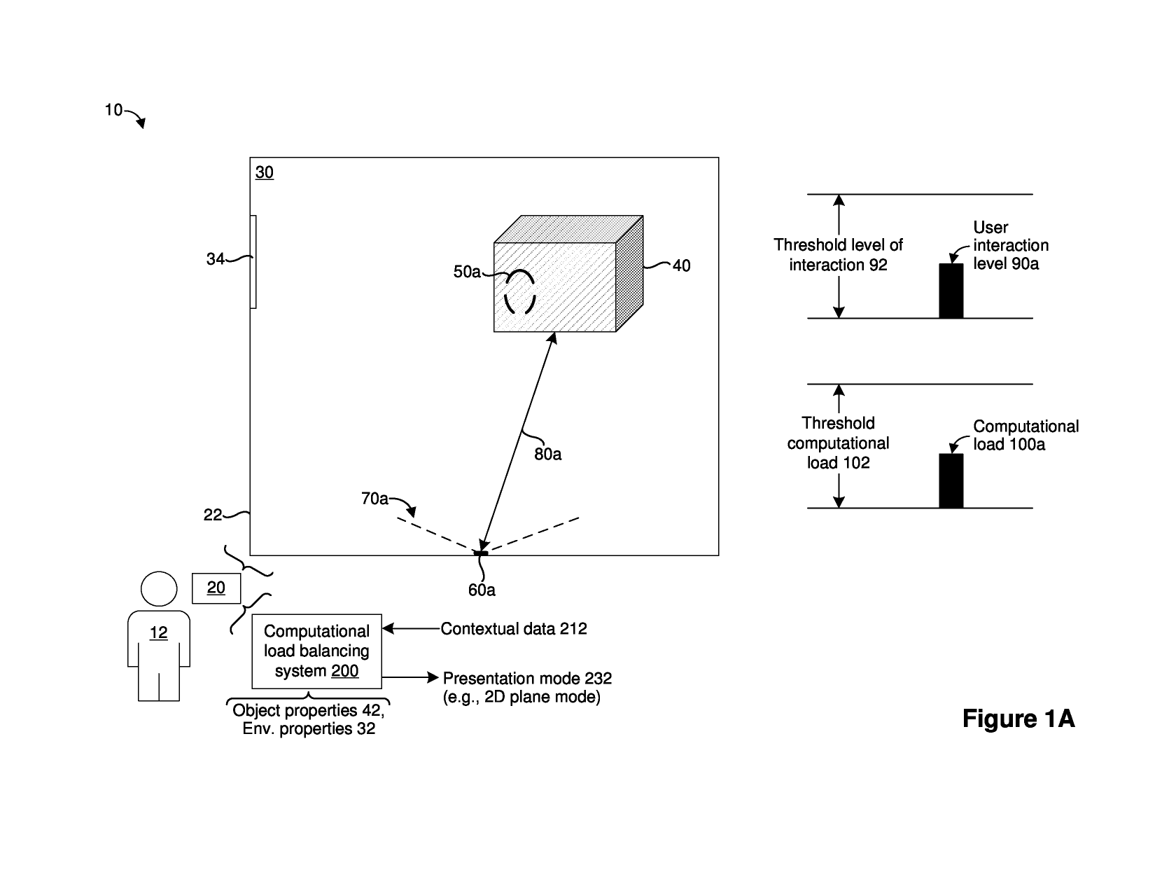

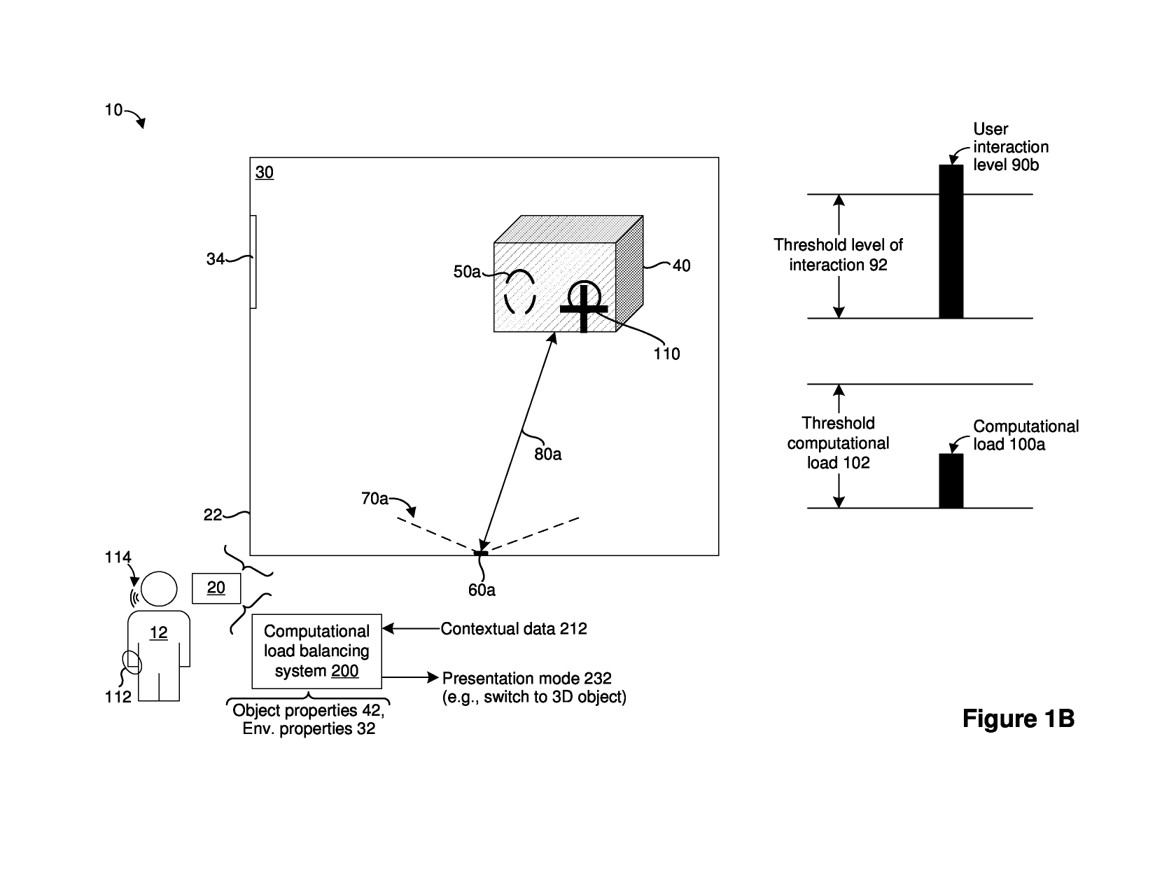

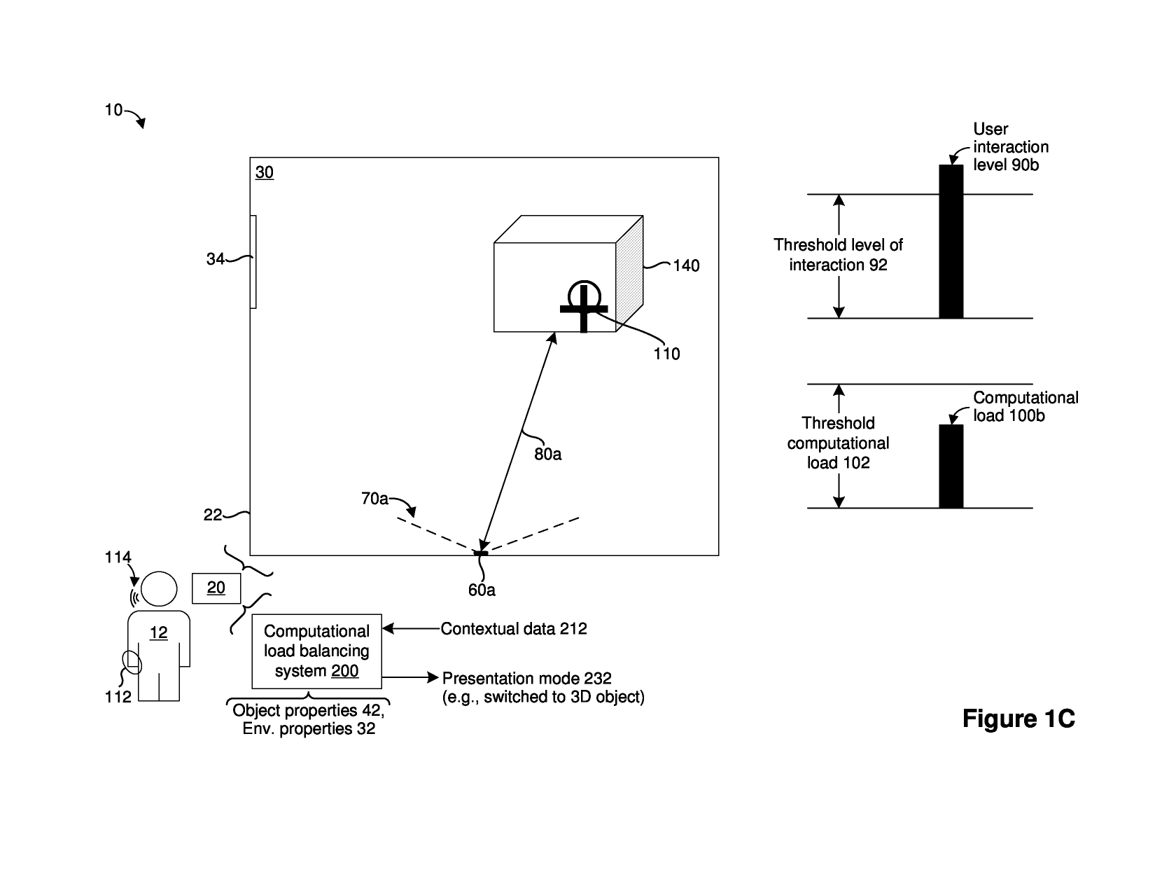

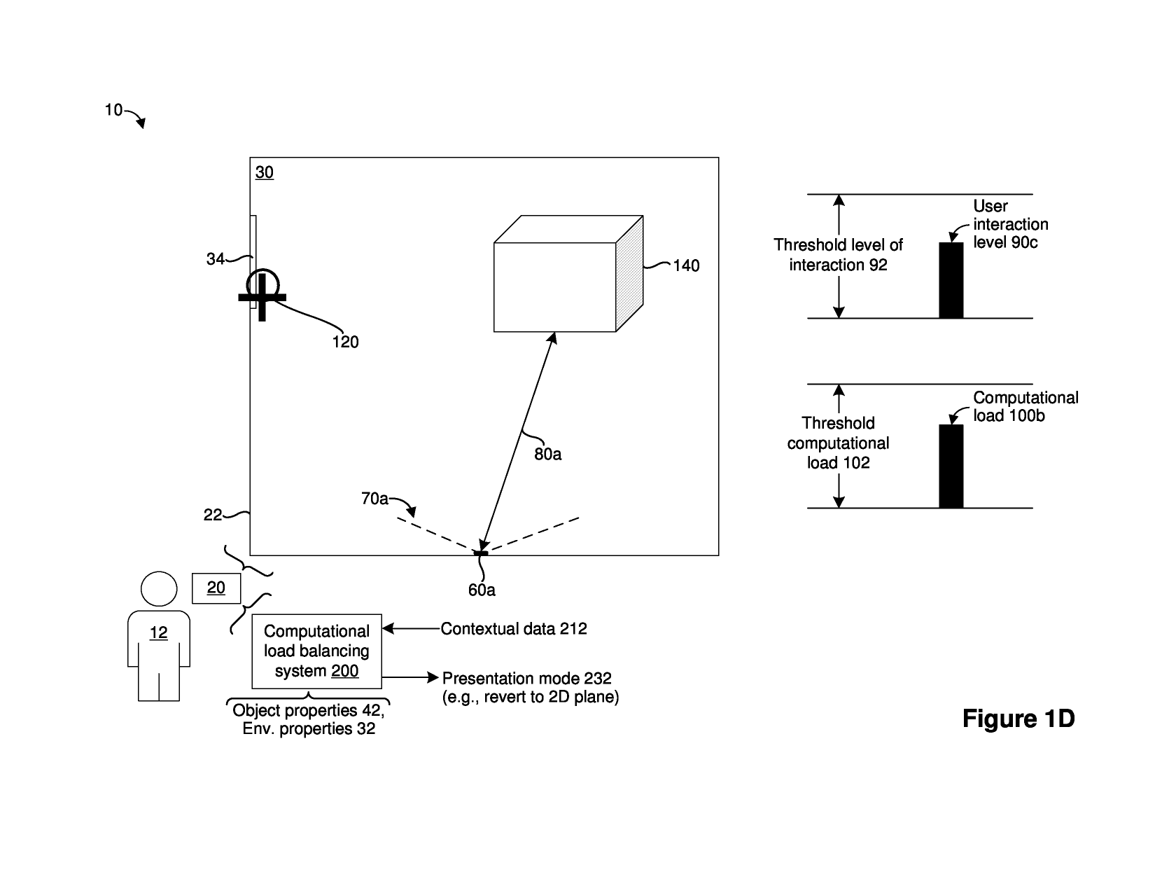

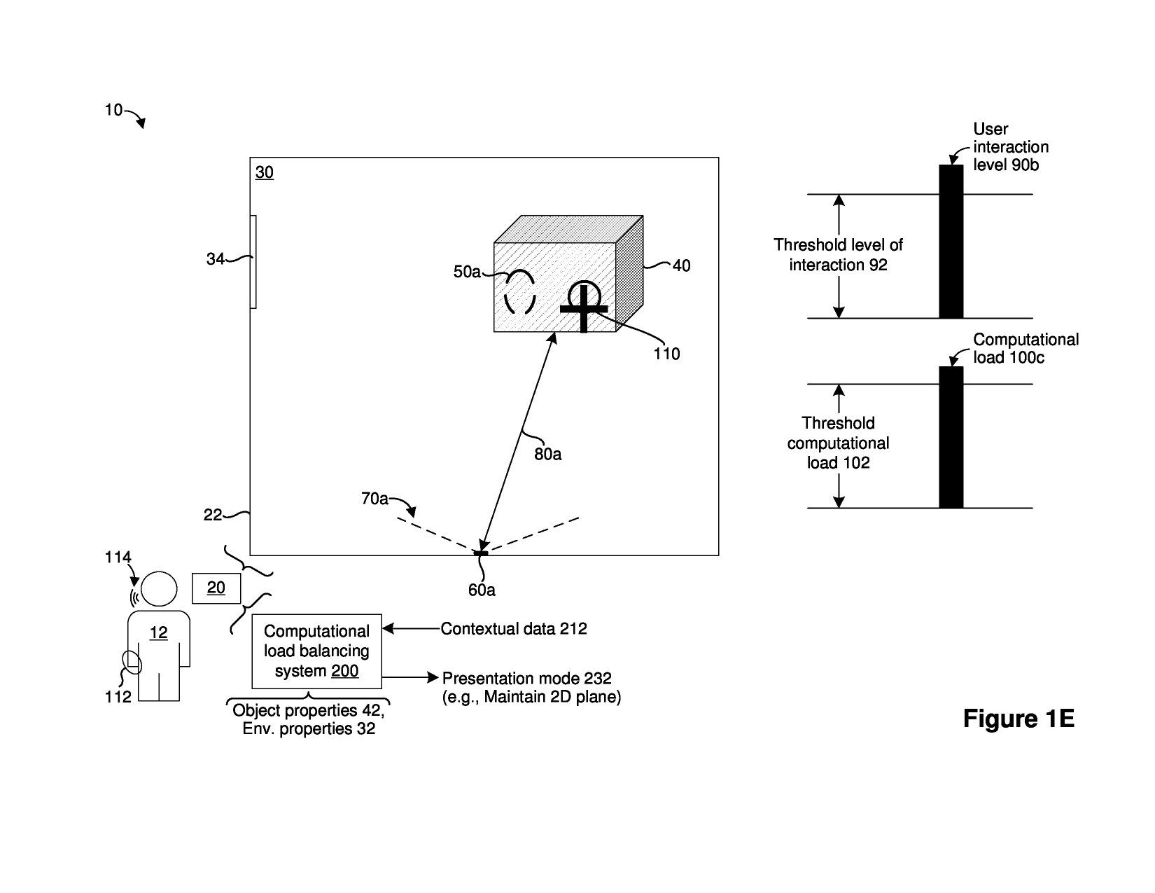

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. In various implementations, the physical environment 10 includes a user 12, an electronic device 20 (“device 20”, hereinafter for the sake of brevity) with a display 22, and a computational load balancing system 200 (“system 200”, hereinafter for the sake of brevity) for balancing computational load during presentation of virtual objects on the display 22. In some implementations, the system 200 resides at the device 20. Alternatively, in some implementations, the system 200 resides at another device that is in electronic communication with the device 20. For example, the device 20 includes a head-mountable device (HMD) and the system 200 resides at a smartphone that is wirelessly connected with the HMD.

In the example of FIG. 1A, the device 20 displays an extended reality (XR) environment. In some implementations, the XR environment is a pass-through representation of the physical environment 10. Alternatively, in some implementations, the XR environment is a virtual environment 30. In the example of FIG. 1A, the virtual environment 30 includes a two-dimensional (2D) plane 40 (“2D plane 40”, hereinafter for the sake of brevity) that represents a three-dimensional (3D) virtual object (not shown). The system 200 displays the 2D plane 40 with a first shading pattern 50a in order to provide an appearance that the 2D plane 40 is the 3D virtual object that the 2D plane 40 represents. The first shading pattern 50a makes the 2D plane 40 resemble the 3D virtual object that the 2D plane 40 represents. The first shading pattern 50a is indicated by rightward slanted hatching in FIG. 1A. In some implementations, the 2D plane 40 is an image. For example, the 2D plane 40 is an image of the 3D virtual object that the 2D plane 40 represents.

In the example of FIG. 1A, the device 20 displays the virtual environment 30 from a first user location 60a within the virtual environment 30. The first user location 60a corresponds to a first set of three-dimensional (3D) coordinates within the virtual environment 30. The first user location 60a is associated with a first point-of-view (POV) 70a. In the example of FIG. 1A, the first POV 70a is conical. Areas of the virtual environment 30 that are within the first POV 70a are visible to the user 12 while a remainder of the virtual environment 30 is not visible to the user 12. The first user location 60a is a first distance 80a from the 2D plane 40. In some implementations, the device 20 identifies 3D coordinates of the 3D virtual object that the 2D plane 40 represents, and the first distance 80a represents a difference between the first user location 60a and the 3D coordinates of the 3D virtual object represented by the 2D plane 40.

In some implementations, the first shading pattern 50a is a function of the first distance 80a. For example, the system 200 accepts a value representing the first distance 80a as an input and outputs parameter values corresponding to the first shading pattern 50a. In this example, the device 20 applies the parameter values corresponding to the first shading pattern 50a to the 2D plane 40 in order to make the 2D plane 40 simulate the appearance of a 3D virtual object from the first POV 70a. Applying the first shading pattern 50a to the 2D plane 40 is less resource-intensive than displaying the 3D virtual object that the 2D plane 40 represents. For example, displaying the 2D plane 40 with the first shading pattern 50a reduces the need to invoke a 3D object renderer that renders 3D virtual objects thereby conserving graphics processing time and power that the 3D object renderer would consume. Hence, displaying the 2D plane 40 with the first shading pattern 50a improves a functionality of the device 20 by reducing resource utilization, decreasing power consumption and lowering heat generation thereby allowing the user 12 to use the device 20 safely for an extended time duration.

In some implementations, the system 200 utilizes a shading model to generate the first shading pattern 50a. In some implementations, the shading model uses flat shading by applying a uniform shading across the 2D plane 40. The system 200 can use flat shading when the 2D plane 40 represents a relatively simple 3D virtual object with less than a threshold number of polygons. In some implementations, the shading model uses Gourad shading by calculating lighting at vertices and interpolating the shading across a surface connecting the vertices. In some implementations, the shading model uses Phong shading by calculating lighting at each pixel which results in a smoother and more accurate shading effect than flat shading or Gourad shading.

In some implementations, the system 200 determines the first shading pattern 50a based further on environment properties 32 that characterize the virtual environment 30. In some implementations, the environment properties 32 indicate a lighting level of the virtual environment 30. For example, the environment properties 32 indicate an ambient lighting level of the virtual environment 30, locations of light sources, intensities of light sources and/or colors of light emitted by the light sources. In the example of FIG. 1A, the virtual environment 30 includes a window 34. As such, the environment properties 32 may indicate an amount of virtual daylight entering from the window 34 and reaching the location of the 2D image 40. In some implementations, the system 200 (e.g., a shading model utilized by the system 200) accepts the environment properties 32 (e.g., a light intensity value, a light illumination angle, a light color, etc.) as additional inputs and generates the first shading pattern 50a based further on the environment properties 32.

In some implementations, the system 200 determines the first shading pattern 50a based further on object properties 42 that characterize the 3D virtual object that the 2D plane 40 represents. In some implementations, the object properties 42 indicate a set of one or more colors of the 3D virtual object. In some implementations, the object properties 42 include a reflectivity value that indicates a reflectivity of the 3D virtual object (e.g., a shininess level of the 3D virtual object). In some implementations, the object properties 42 indicate a set of one or more materials that the 3D virtual object is constructed from (e.g., leather, wood, stone, etc.). In some implementations, the object properties 42 indicate a texture of the 3D virtual object (e.g., how it feels to touch the 3D virtual object, for example, a smoothness level or a roughness level of the 3D virtual object). In some implementations, the system 200 (e.g., the shading model utilized by the system 200) accepts the object properties 42 (e.g., color, reflectivity, materials, texture, etc.) as additional inputs and generates the first shading pattern 50a based further on the object properties 42.

In some implementations, a shading pattern is characterized by a set of parameter values for various parameters. In some implementations, a shading pattern is associated with a set of values for color parameters. The color parameters may include a base color which indicates a starting color of the shading pattern, an end color indicating a final color in a gradient-type shading pattern, and intermediate colors at specific points in a multi-stop gradient. In some implementations, a shading pattern is associated with gradient parameters for gradient shading. The gradient parameters may include a start point of the gradient, an end point of the gradient, gradient stops indicating specific points where specific colors are applied along the gradient, and gradient type such as linear, radial, conical or angular. In some implementations, a shading pattern is characterized by lighting parameters, for example, an ambient light intensity parameter indicating baseline illumination unaffected by object orientation, a diffuse light intensity parameter indicating light scattered uniformly across a surface, a specular light intensity parameter indicating light reflected in a specific direction causing highlights, a light source direction defining light’s origin or direction, and a shininess or Phong exponent indicating a sharpness of specular highlights. In some implementations, a shading pattern is characterized by texture parameters, opacity or transparency parameters, a reflectivity parameter, a refractivity parameters, pattern-specific parameters (e.g., frequency defining how often a pattern repeats, amplitude defining intensity of the pattern, phase offset defining shifts in pattern along an axis and noise level for procedural or stochastic patterns).

In various implementations, the system 200 obtains contextual data 212 and determines a presentation mode 232 based on the contextual data 212. The contextual data 212 indicates a context of the user 12 or the device 20. The presentation mode 232 includes a 2D plane presentation mode or a 3D virtual object presentation mode. The system 200 uses the contextual data 212 to determine a user interaction level with respect to the 3D virtual object. The user interaction level indicates a degree of engagement of the user 12 with the 3D virtual object or a 2D representation of the 3D virtual object (e.g., whether the user 12 is gazing at the 3D virtual object or interacting with the 3D virtual object). In the example of FIG. 1A, the system 200 determines a first user interaction level 90a with respect to the 3D virtual object. When the user interaction level is below a threshold level of interaction 92, the system 200 presents the 2D plane 40 instead of the 3D virtual object. In the example of FIG. 1A, the system 200 presents the 2D plane 40 since the first user interaction level 90a is less than the threshold level of interaction 92.

In some implementations, the contextual data 212 indicates a user input provided by the user 12. In some implementations, the user input includes a gaze input that indicates a gaze position, a gaze duration and/or a gaze intensity of the user 12. For example, the user input indicates whether or not the user 12 is gazing towards a location corresponding to the 3D virtual object that the 2D plane 40 represents. In some implementations, the user input includes a gesture input. For example, the user input includes a pointing gesture or a pinch-and-drag gesture directed to the 3D virtual object or the 2D plane 40. In some implementations, the user input includes a voice input (e.g., a voice command directed to the 3D virtual object or the 2D plane 40 representing the 3D virtual object).

In some implementations, the system 200 determines a computational load of the device 20. The computational load indicates a current resource utilization of the device 20. In some implementations, the computational load indicates an amount of graphics processing resources that are currently being utilized for displaying virtual objects. In some implementations, the computational load indicates a temperature of the device 20. In some implementations, the computational load indicates a battery status of the device 20. More generally, in various implementations, the computational load indicates a resource status of the device 20. In the example of FIG. 1A, the system 200 determines that the device 20 is currently operating at a first computational load 100a that is less than a threshold computational load 102.

Referring to FIG. 1B, the device 20 detects a user input directed to the 2D plane 40. For example, the device 20 detects a gaze input 110 directed to the 2D plane 40, a gesture input 112 directed to the 2D plane 40 and/or a voice input directed to the 3D virtual object that the 2D plane 40 represents. In response to detecting one or more of the inputs 110, 112 and 114, the system 200 determines that the user interaction level has increased to a second user interaction level 90b. The second user interaction level 90b is greater than the threshold level of interaction 92. Since the computational load of the device 20 is still below the threshold computational load 102, the system 200 determines to switch from the 2D plane presentation mode to the 3D virtual object presentation mode. In some implementations, the system 200 maintains the 2D plane presentation mode when the computational load is greater than the threshold computational load 102 even when the user interaction level is greater than the threshold level of interaction 92.

Referring to FIG. 1C, the system 200 switches to the 3D virtual object presentation mode. As such, the system 200 replaces the 2D plane 40 with a 3D virtual object 140. Switching to displaying the 3D virtual object 140 increases a computational load of the device 20 to a second computational load 100b. The second computational load 100b is still below the threshold computational load 102. As such, the system 200 maintains the 3D virtual object presentation mode and continues presenting the 3D virtual object 140. If the computational load increases to a value that is greater than the threshold computational load 102, then the system 200 reverts to the 2D plane presentation mode and replaces the 3D virtual object 140 with the 2D plane 40. In some implementations, the system 200 reverts to the 2D plane presentation mode when a temperature of the device 20 exceeds a threshold temperature. Reverting to the 2D plane presentation mode can reduce heat generation caused by 3D object rendering and lower the temperature to a value that is below the threshold temperature.

Referring to FIG. 1D, in some implementations, the system 200 reverts from the 3D virtual object presentation mode to the 2D plane presentation mode when the user interaction level drops to a value that is less than the threshold level of interaction 92. In the example of FIG. 1D, the device 20 detects a gaze input 120 that is directed away from the 3D virtual object 140 and at the window 34. Since the user 12 is not looking at the 3D virtual object 140 or otherwise interacting with the 3D virtual object 140, the system 200 determines a third user interaction level 90c that is below the threshold level of interaction 92. In response to the third user interaction level 90c being less than the threshold level of interaction 92, the system 200 determines to revert to the 2D plane presentation mode by replacing the 3D virtual object 140 with the 2D plane 40.

Referring to FIG. 1E, in some implementations, the system 200 determines to maintain the 2D plane presentation mode based on the computational load even when the user interaction level is greater than the threshold level of interaction 92. In the example of FIG. 1E, the system 200 determines a third computational load 100c that is greater than the threshold computational load 102. The system 200 determines the second interaction level 90b that is greater than the threshold level of interaction 92. Since the third computational load 100c is greater than the threshold computational load 102, the system 200 determines to maintain the 2D plane presentation mode even though the second user interaction level 90b is greater than the threshold level of interaction 92. Maintaining the 2D plane presentation mode when the computational load exceeds the threshold computational load 102 prevents further overloading the device 20, prevents additional heat generation and/or prevents accelerated battery drainage.

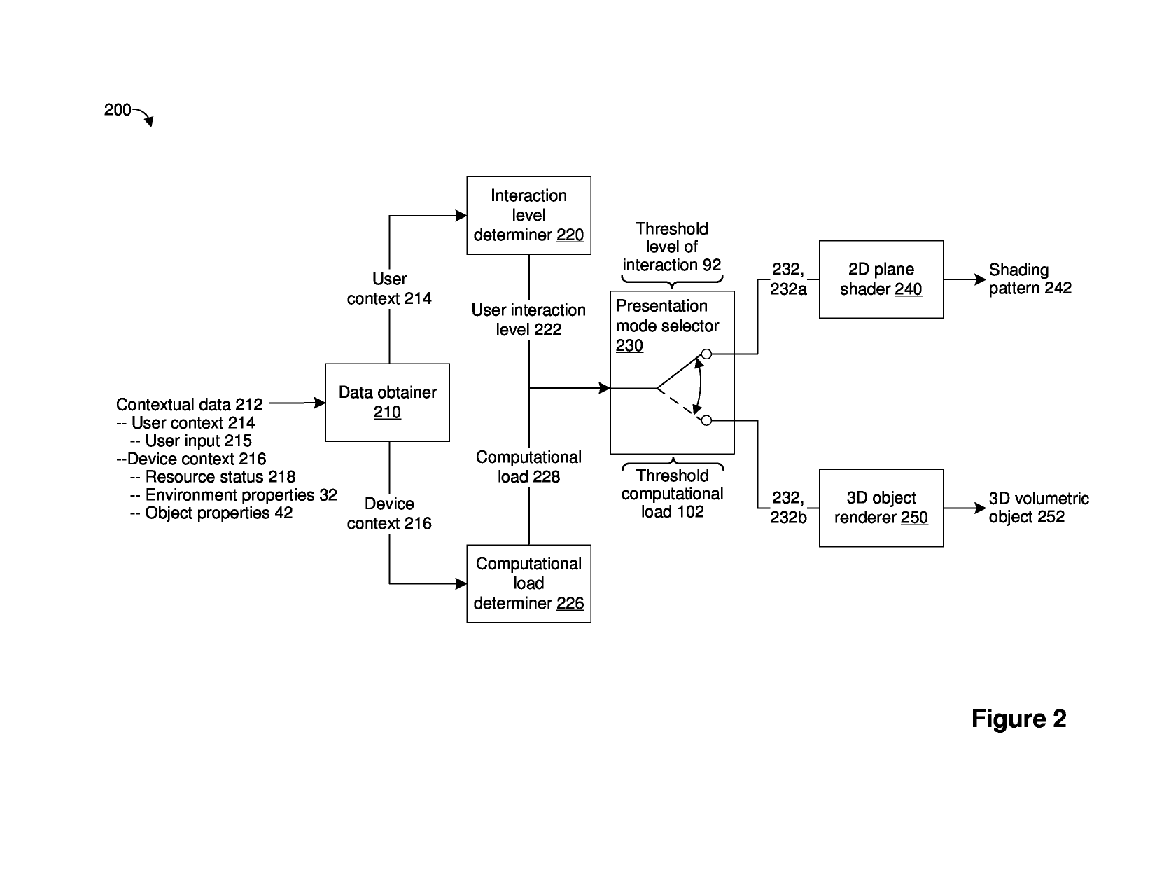

FIG. 2 is a block diagram of the system 200 in accordance with some implementations. In some implementations, the system 200 includes a data obtainer 210, an interaction level determiner 220, a computational load determiner 226, a presentation mode selector 230, a 2D plane shader 240 and a 3D object renderer 250.

In various implementations, the data obtainer 210 obtains the contextual data 212 that indicates a context of the device 20 or the user 12 of the device 20 shown in FIGS. 1A-1E. In some implementations, the contextual data 212 indicates a user context 214 (e.g., a context of the user). For example, in some implementations, the contextual data 212 includes a user input 215 (e.g., a gaze input, a gesture input and/or a voice input, for example, the inputs 110, 112 and 114 shown in FIG. 1B). The data obtainer 210 provides the user context 214 to the interaction level determiner 220.

In some implementations, the contextual data 212 indicates a device context 216 (e.g., a context of the device 20 shown in FIGS. 1A-1E). In some implementations, the device context 216 includes a resource status 218, the environment properties 32 and/or the object properties 42. In some implementations, the resource status 218 includes a resource utilization level and/or a resource availability. In some implementations, the resource status 218 indicates a computational load of the device (e.g., the first computational load 100a shown in FIG. 1A). In some implementations, the resource status 218 indicates a utilization level of a 3D rendering engine or an availability of a 3D rendering engine. In some implementations, the resource status 218 indicates a utilization of graphics processing resources (e.g., a utilization of a graphics processing unit (GPU)) or an availability of the graphics processing resources (e.g., an availability of the GPU). In some implementations, the resource status 218 indicates a battery level of the device and/or a temperature of the device.

In some implementations, the environment properties 32 indicates a number of 3D virtual objects in the virtual environment. In some implementations, the object properties 42 for a 3D virtual object indicate a complexity of the 3D virtual object. For example, the object properties 42 indicate a number of polygons, a density of polygons and/or shapes of polygons in a mesh of the 3D virtual object. The data obtainer 210 provides the device context 216 to the computational load determiner 226.

In various implementations, the interaction level determiner 220 determines a user interaction level 222 (e.g., the first user interaction level 90a shown in FIG. 1A) based on the user context 214. In some implementations, the user interaction level 222 indicates a degree of engagement of the user with a 3D virtual object or a with a 2D plane representing the 3D virtual object. For example, the user interaction level 222 indicates the first user interaction level 90a of the user 12 with respect to the 2D plane 40 shown in FIG. 1A. In some implementations, the interaction level determiner 220 determines the user interaction level 222 based on the user input 215. As an example, the interaction level determiner 220 sets the user interaction level 222 to a relatively high value when the user input 215 indicates that the user has been gazing at the 3D virtual object or the 2D plane representing the 3D virtual object for greater than a threshold amount of time. As another example, the interaction level determiner 220 sets the user interaction level 222 to a relatively high value when the user input 215 includes a gesture (e.g., a request to manipulate) or a voice command that is directed to the 3D virtual object or the 2D version of the 3D virtual object. By contrast, the interaction level determiner 220 sets the user interaction level 222 to a relatively low value when the user is gazing away from the 3D virtual object or the 2D representation of the 3D virtual object. As another example, the interaction level determiner 220 sets the user interaction level 222 to a relatively low value when the user is gesturing at or vocally interacting with another 3D virtual object in the virtual environment. The interaction level determiner 220 provides an indication of the user interaction level 222 to the presentation mode selector 230.

In various implementations, the computational load determiner 226 determines a computational load 228 (e.g., the first computational load 100a shown in FIG. 1A) of the device based on the device context 216. In some implementations, the computational load determiner 226 determines the computational load 228 based on the resource status 218. As an example, if the resource status 218 indicates a low utilization of graphics processing resources (e.g., the GPU), the computational load determiner 226 sets a relatively low value for the computational load 228. By contrast, if the resource status 218 indicates a relatively high utilization of the graphical processing resources (e.g., GPU), the computational load determiner 226 sets a relatively high value for the computational load 228. In some implementations, the computational load determiner 226 determines the computational load 228 based on a battery level of the device. For example, if the battery level is below a threshold (e.g., less than 5%), the computational load determiner 226 may set the computational load 228 to a relatively high value. By contrast, if the battery level is above a threshold (e.g., greater than 50%), the computational load determiner 226 can set the computational load 228 to a relatively low value. In some implementations, the computational load determiner 226 determines the computational load 228 based on a temperature of the device. For example, if the device temperature is greater than a threshold temperature, the computational load determiner 226 sets the computational load 228 to a relatively high value.

In some implementations, the computational load determiner 226 determines the computational load 228 based on the environment properties 32. In some implementations, the environment properties 32 indicate a number of 3D virtual objects in the virtual environment and the computational load 228 is a function of the number of 3D virtual objects in the virtual environment. For example, the computational load 228 is directly proportional to the number of 3D virtual objects in the virtual environment. In some implementations, the computational load determiner 226 determines the computational load 228 based on the object properties 42. In some implementations, the object properties 42 indicate a complexity of the 3D virtual object and the computational load 228 is a function of the complexity of the 3D virtual object. For example, a 3D virtual object with a relatively high number of polygons results in a higher computational load 228. The computational load determiner 226 provides an indication of the computational load 228 to the presentation mode selector 230.

In various implementations, the presentation mode selector 230 determines a presentation mode based on the user interaction level 222 and the computational load 228. In some implementations, the presentation mode selector 230 selects between a 2D plane presentation mode 232a and a 3D virtual object presentation mode 232b based on the user interaction level 222 and the computational load 228. In some implementations, the presentation mode selector 230 determines whether the user interaction level 222 exceeds the threshold level of interaction 92. If the user interaction level 222 does not exceed the threshold level of interaction 92, the presentation mode selector 230 selects the 2D plane presentation mode 232a and invokes the 2D plane shader 240. Alternatively, if the user interaction level 222 exceeds the threshold level of interaction 92, the presentation mode selector 230 determines whether the computational load 228 exceeds the threshold computational load 102. If the computational load 228 exceeds the threshold computational load 102, the presentation mode selector 230 selects the 2D plane presentation mode 232a and invokes the 2D plane shader 240. Alternatively, if the computational load 228 does not exceed the threshold computational load 102, the presentation mode selector 230 selects the 3D virtual object presentation mode 232b and invokes the 3D object renderer 250.

The 2D plane shader 240 determines a shading pattern 242 to apply to a 2D plane in the 2D plane presentation mode. For example, the 2D plane shader 240 determines the first shading pattern 50a shown in FIG. 1A. As described herein, the 2D plane shader 240 utilizes a shading model to generate the shading pattern 242. To that end, the 2D plane shader 240 may utilize some of the data obtained by the data obtainer 210 to determine the shading pattern 242. For example, in some implementations, the shading pattern 242 is a function of the environment properties 32 (e.g., lighting levels, illumination angle, light color, etc.) and/or the object properties 42 (e.g., object colors, reflectivity, materials, textures, etc.).

The 3D object renderer 250 is invoked when the presentation mode selector 230 selects the 3D virtual object presentation mode 232b. The 3D object renderer 250 generates a 3D volumetric object 252 (e.g., the 3D virtual object 140 shown in FIG. 1C). The 3D object renderer 250 tends to consume more graphics computing resources than the 2D plane shader 240 and the 3D object renderer 250 tends to result in greater heat generation than the 2D plane shader 240. Hence, the devices, methods and systems described herein reduce an amount of time that the 3D object renderer 250 is invoked and increase an amount of time that the 2D plane shader 240 is invoked.

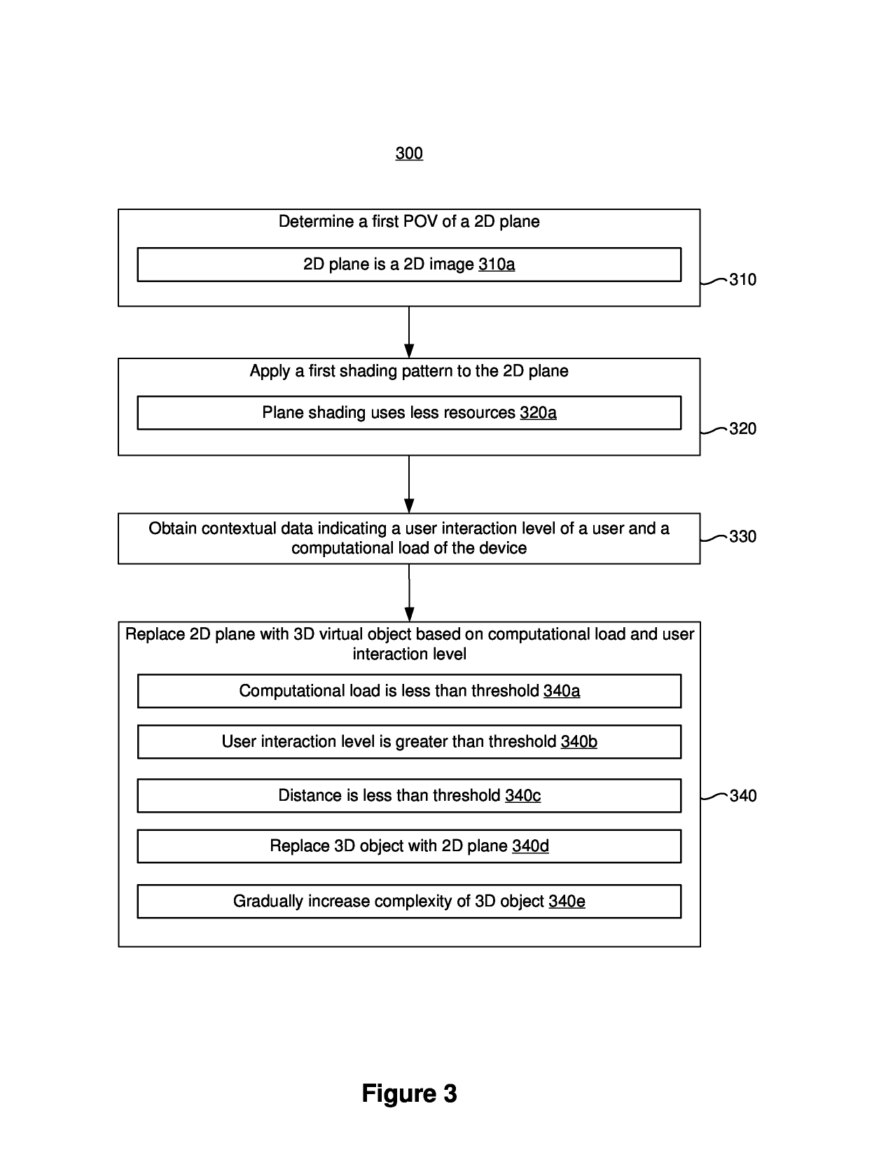

FIG. 3 is a flowchart representation of a method 300 for balancing computational load. In various implementations, the method 300 is performed by a device including a display, a non-transitory memory and one or more processors coupled with the display and the non-transitory memory (e.g., the device 20 shown in FIGS. 1A-1E and/or the system 200 shown in FIGS. 1A-2). In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in various implementations, the method 300 includes determining a first point-of-view (POV) of a two-dimensional (2D) plane representing a three-dimensional (3D) virtual object from a user location characterized by a set of coordinates in a virtual environment and a distance between the user location and a location corresponding to the 3D virtual object. For example, as shown in FIG. 1A, the device 20 displays the 2D plane 40 representing a 3D virtual object from the first POV 70a.

As represented by block 310a, in some implementations, the 2D plane representing the 3D virtual object is a 2D image. For example, referring to FIG. 1A, in some implementations, the 2D plane 40 is an image of the 3D virtual object 140 shown in FIG. 1C. In some implementations, the system 200 captures images of the 3D virtual object 140 from various different perspectives and selects one of the captured images that was captured from a perspective that most closely matches the first POV 70a.

As represented by block 320, in some implementations, the method 300 includes applying a first shading pattern to the 2D plane based on the first POV in order to make the 2D plane appear as a 3D version of the 3D virtual object from the first POV. For example, as shown in FIG. 1A, the system 200 applies the first shading pattern 50a to the 2D plane 40 in order to make the 2D plane 40 look like the 3D virtual object 140 (shown in FIG. 1C) that the 2D plane 40 represents.

As represented by block 320a, applying the first shading pattern to the 2D plane comprises utilizing a 2D plane shader that consumes a first amount of computational resources, and replacing the 2D plane with the 3D virtual object includes utilizing a 3D object rendering engine that consumes a second amount of computational resources that is greater than the first amount of computational resources. For example, referring to FIGS. 1A, 1C and 2, displaying the 2D plane 40 with the first shading pattern 50a uses fewer computing resources than displaying the 3D virtual object 140 because the 2D plane shader 240 is computationally less intensive than the 3D object renderer 250.

As represented by block 330, in some implementations, the method 300 includes obtaining contextual data that indicates a context of the device or a user of the device. The contextual data indicates a user interaction level with the 2D plane representing the 3D virtual object and a current computational load of the device. For example, as shown in FIG. 2, the system 200 obtains the contextual data 212 that indicates the user context 214 and/or the device context 216. In some implementations, the device obtains the contextual data from various on-device sensors or off-device sensors (e.g., remote sensors). For example, the device obtains the user input 215 from an input device (e.g., gaze inputs from an eye tracker, gesture inputs from a user-facing camera and voice inputs from a microphone). In some implementations, the device determines the contextual data by analyzing telemetry data collected by the device, monitoring a rendering display pipeline, tracking GPU load and/or analyzing application data.

As represented by block 340, in various implementations, the method 300 includes replacing the 2D plane representing the 3D virtual object with the 3D virtual object based on a combination of the current computational load of the device and a change in the user interaction level with the 2D plane representing the 3D virtual object. For example, as shown in FIG. 1C, the device 20 replaces the 2D plane 40 with the 3D virtual object 140 when the second user interaction level 90b exceeds the threshold level of interaction 92 and the second computational load 100b is below the threshold computational load 102.

As represented by block 340a, in some implementations, replacing the 2D plane with the 3D virtual object includes replacing the 2D plane with the 3D virtual object when the current computational load is less than a threshold computational load. For example, as shown in FIG. 1C, the device 20 replaces the 2D plane 40 with the 3D virtual object 140 when the second computational load 100b is less than the threshold computational load 102 and the second user interaction level 90b is greater than the threshold level of interaction 92. Replacing the 2D plane with the 3D virtual object when the computational load is less than the threshold computational load helps maintain a frame rate above an acceptable frame rate.

In some implementations, the current computational load is a function of a complexity of the virtual environment. In some implementations, the complexity of the virtual environment is a function of a number of 3D virtual objects in the virtual environment, a geometry of each 3D virtual object and/or a number of polygons in a mesh of each of the 3D virtual objects. For example, as the number of the 3D virtual objects increases, the computational load increases in order to render the 3D virtual objects. Similarly, an increasingly complex geometry (e.g., a virtual object with more geometric variations such as more edges and corners) results in an increased computational load.

In some implementations, the current computational load is a function of a user movement and an amount of change in frame-by-frame presentation of the virtual environment. For example, if the user is moving a lot (e.g., amount of user movement is greater than threshold amount of movement) or content displayed within the virtual environment is changing relatively quickly, then the computational load is going to be relatively high. By contrast, if the user is relatively stationary (e.g., amount of user movement is less than the threshold amount of movement) and the content displayed within the virtual environment is mostly static, then the computational load is going to be relatively low.

As represented by block 340b, in some implementations, replacing the 2D plane with the 3D virtual object includes replacing the 2D plane with the 3D virtual object when the user interaction level is greater than a threshold level of interaction. For example, as shown in FIG. 1B, the system 200 determines to replace the 2D plane 40 with the 3D virtual object 140 when the second user interaction level 90b is greater than the threshold level of interaction 92 and the first computational load 100a is less than the threshold computational load 102. In some implementations, the device determines that the user interaction level is greater than the threshold level of interaction when the user gazes at the 2D plane for more than a threshold amount of time, when the user performs a gesture that is directed to the 2D plane and/or when the user issues a verbal command that is directed to the 2D plane.

As represented by block 340c, in some implementations, replacing the 2D plane with the 3D virtual object includes replacing the 2D plane with the 3D virtual object when the distance between the user location and the location corresponding to the 3D virtual object is less than a threshold distance. For example, the device replaces the 2D plane with the 3D virtual object when the user is so close to the 2D plane that it is difficult to maintain an illusion that the 2D plane is the 3D virtual object.

As represented by block 340d, in some implementations, the method 300 includes determining to display the 2D plane instead of the 3D virtual object when the user interaction level with the 3D virtual object is less than a threshold level of interaction or when the current computational load is greater than threshold computational load. As an example, the device determines to replace the 3D virtual object with the 2D plane when the user is looking away from the 3D virtual object or when the frame rate drops to a frame rate value that is below an acceptable frame rate threshold. As another example, referring to FIG. 1E, the device 20 determines to maintain the 2D plane presentation mode in response to the third computational load 100c being greater than the threshold computational load 102 even though the second user interaction level 90b is greater than the threshold level of interaction 92.

As represented by block 340e, in some implementations, the method 300 includes gradually increasing a complexity of the 3D virtual object in order to maintain the current computational load below a threshold computational load. For example, referring to FIG. 1C, after switching from the 2D plane 40 to the 3D virtual object 140, the device 20 slowly increases a number of polygons in a mesh of the 3D virtual object 140 in order to prevent a surge in the computational load. In some implementations, the device increases the complexity of the 3D virtual object to an extent that the rendered complexity does not cause the computational load to exceed the threshold computational load.

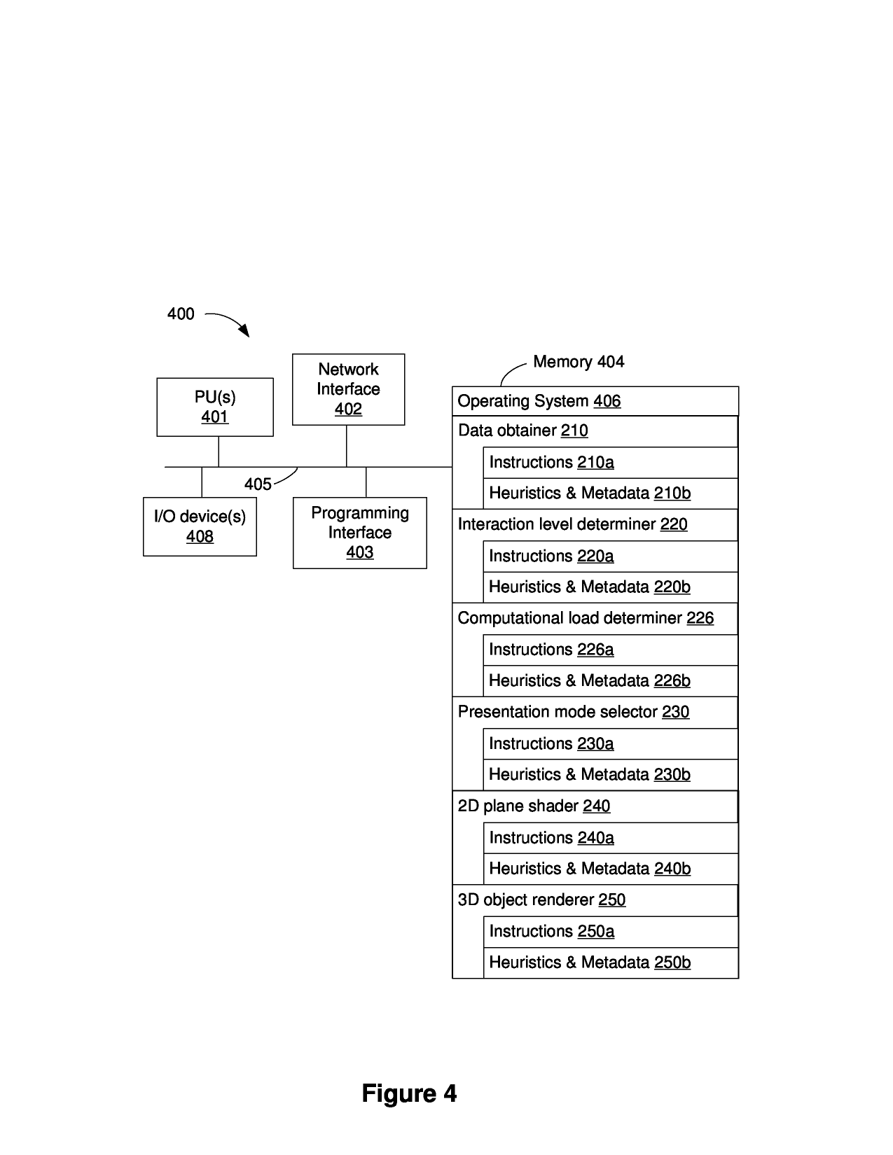

FIG. 4 is a block diagram of a device 400 in accordance with some implementations. In some implementations, the device 400 implements the device 20 shown in FIGS. 1A-1E and/or the system 200 shown in FIGS. 1A-2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (PUs) 401, a network interface 402, a programming interface 403, a memory 404, one or more input/output (I/O) devices 408, and one or more communication buses 405 for interconnecting these and various other components.

In some implementations, the PU(s) 401 includes one or more central processing units (CPU(s)), one or more graphics processing units (GPU(s)) and/or one or more neural processing units (NPU(s)).

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more PUs 401. The memory 404 comprises a non-transitory computer readable storage medium.

In some implementations, the memory 404 or the non-transitory computer readable storage medium of the memory 404 stores the following programs, modules and data structures, or a subset thereof including an optional operating system 406, the data obtainer 210, the interaction level determiner 220, the computational load determiner 226, the presentation mode selector 230, the 2D plane shader 240 and the 3D object renderer 250. In various implementations, the device 400 performs the method 300 shown in FIG. 3.

In some implementations, the data obtainer 210 includes instructions 210a, and heuristics and metadata 210b for obtaining contextual data (e.g., the contextual data 212 shown in FIGS. 1A-2). In some implementations, the data obtainer 210 performs at least some of the operation(s) represented by blocks 310 and 330 in FIG. 3.

In some implementations, the interaction level determiner 220 includes instructions 220a, and heuristics and metadata 220b for determining a user interaction level (e.g., the user interaction level 222 shown in FIG. 2). In some implementations, the interaction level determiner 220 performs at least some of the operation(s) represented by block 340 in FIG. 3.

In some implementations, the computational load determiner 226 includes instructions 226a, and heuristics and metadata 226b for determining a computational load of the device (e.g., the computational load 228 shown in FIG. 2). In some implementations, the computational load determiner 226 performs at least some of the operation(s) represented by block 340 in FIG. 3.

In some implementations, the presentation mode selector 230 includes instructions 230a, and heuristics and metadata 230b for selecting between a 2D plane presentation mode and a 3D virtual object presentation mode (e.g., selecting one of the modes 232a and 232b shown in FIG. 2). In some implementations, the presentation mode selector 230 performs at least some of the operation(s) represented by block 340 in FIG. 3.

In some implementations, the 2D plane shader 240 includes instructions 240a, and heuristics and metadata 240b for determining and applying shading patterns (e.g., the first shading pattern 50a shown in FIG. 1A) to a 2D plane in order to make the 2D plane appear as a 3D virtual object. In some implementations, the 2D plane shader 240 performs at least some of the operation(s) represented by blocks 310 and 320 in FIG. 3.

In some implementations, the 3D object renderer 250 includes instructions 250a, and heuristics and metadata 250b for displaying a 3D virtual object (e.g., the 3D virtual object 140 shown in FIG. 1C). In some implementations, the 3D object renderer 250 performs at least some of the operation(s) represented by block 340 in FIG. 3.

In some implementations, the one or more I/O devices 408 include a set of one or more sensors for detecting user inputs. For example, the one or more I/O devices 408 include an eye tracker for detecting gaze inputs, a gesture tracker for detecting gestures and a microphone for detecting verbal commands.

In various implementations, the one or more I/O devices 408 include a video pass-through display which displays at least a portion of a physical environment surrounding the device 400 as an image captured by the camera. In various implementations, the one or more I/O devices 408 include an optical see-through display which is at least partially transparent and passes light emitted by or reflected off the physical environment.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at a device including a non-transitory memory, an input device, a display and one or more processors:
determining a first point-of-view (POV) of a two-dimensional (2D) plane representing a three-dimensional (3D) virtual object from a user location characterized by a set of coordinates in a virtual environment and a distance between the user location and a location corresponding to the 3D virtual object;
applying a first shading pattern to the 2D plane based on the first POV in order to make the 2D plane appear as a 3D version of the 3D virtual object from the first POV;
obtaining contextual data that indicates a context of the device or a user of the device, wherein the contextual data indicates a user interaction level with the 2D plane representing the 3D virtual object and a current computational load of the device; and
replacing the 2D plane representing the 3D virtual object with the 3D virtual object based on a combination of the current computational load of the device and a change in the user interaction level with the 2D plane representing the 3D virtual object.

2. The method of claim 1, wherein replacing the 2D plane with the 3D virtual object comprises replacing the 2D plane with the 3D virtual object when the current computational load is less than a threshold computational load.

3. The method of claim 1, wherein the current computational load is a function of a complexity of the virtual environment.

4. The method of claim 1, wherein the current computational load is a function of a user movement and an amount of change in frame-by-frame presentation of the virtual environment.

5. The method of claim 1, wherein replacing the 2D plane with the 3D virtual object comprises replacing the 2D plane with the 3D virtual object when the user interaction level is greater than a threshold level of interaction.

6. The method of claim 1, wherein replacing the 2D plane with the 3D virtual object comprises replacing the 2D plane with the 3D virtual object when the distance between the user location and the location corresponding to the 3D virtual object is less than a threshold distance.

7. The method of claim 1, wherein applying the first shading pattern to the 2D plane comprises utilizing a 2D plane shader that consumes a first amount of computational resources; and
wherein replacing the 2D plane with the 3D virtual object comprises utilizing a 3D object rendering engine that consumes a second amount of computational resources that is greater than the first amount of computational resources.

8. The method of claim 1, wherein the 2D plane representing the 3D virtual object is a 2D image.

9. The method of claim 1, further comprising determining to display the 2D plane instead of the 3D virtual object when the user interaction level with the 3D virtual object is less than a threshold level of interaction or when the current computational load is greater than threshold computational load.

10. The method of claim 1, further comprising gradually increasing a complexity of the 3D virtual object in order to maintain the current computational load below a threshold computation load.

11. A device comprising:
a non-transitory memory;
an input device;
a display; and
one or more processors to:
determine a first point-of-view (POV) of a two-dimensional (2D) plane representing a three-dimensional (3D) virtual object from a user location characterized by a set of coordinates in a virtual environment and a distance between the user location and a location corresponding to the 3D virtual object;
apply a first shading pattern to the 2D plane based on the first POV in order to make the 2D plane appear as a 3D version of the 3D virtual object from the first POV;
obtain contextual data that indicates a context of the device or a user of the device, wherein the contextual data indicates a user interaction level with the 2D plane representing the 3D virtual object and a current computational load of the device; and
replace the 2D plane representing the 3D virtual object with the 3D virtual object based on a combination of the current computational load of the device and a change in the user interaction level with the 2D plane representing the 3D virtual object.

12. The device of claim 11, wherein the one or more processors are to replace the 2D plane with the 3D virtual object by replacing the 2D plane with the 3D virtual object when the current computational load is less than a threshold computational load.

13. The device of claim 11, wherein the current computational load is a function of a complexity of the virtual environment.

14. The device of claim 11, wherein the current computational load is a function of a user movement and an amount of change in frame-by-frame presentation of the virtual environment.

15. The device of claim 11, wherein the one or more processors are to replace the 2D plane with the 3D virtual object by replacing the 2D plane with the 3D virtual object when the user interaction level is greater than a threshold level of interaction.

16. The device of claim 11, wherein the one or more processors are to replace the 2D plane with the 3D virtual object by replacing the 2D plane with the 3D virtual object when the distance between the user location and the location corresponding to the 3D virtual object is less than a threshold distance.

17. The device of claim 11, wherein the one or more processors are to apply the first shading pattern to the 2D plane by utilizing a 2D plane shader that consumes a first amount of computational resources; and
wherein the one or more processors are to replace the 2D plane with the 3D virtual object by utilizing a 3D object rendering engine that consumes a second amount of computational resources that is greater than the first amount of computational resources.

18. The device of claim 11, wherein the one or more processors are further to determine to display the 2D plane instead of the 3D virtual object when the user interaction level with the 3D virtual object is less than a threshold level of interaction or when the current computational load is greater than threshold computational load.

19. The device of claim 11, wherein the one or more processors are further to gradually increase a complexity of the 3D virtual object in order to maintain the current computational load below a threshold computation load.

20. A non-transitory memory storing one or more programs, which, when executed by one or more processors of a device including an input device and a display, cause the device to:
determine a first point-of-view (POV) of a two-dimensional (2D) plane representing a three-dimensional (3D) virtual object from a user location characterized by a set of coordinates in a virtual environment and a distance between the user location and a location corresponding to the 3D virtual object;
apply a first shading pattern to the 2D plane based on the first POV in order to make the 2D plane appear as a 3D version of the 3D virtual object from the first POV;
obtain contextual data that indicates a context of the device or a user of the device, wherein the contextual data indicates a user interaction level with the 2D plane representing the 3D virtual object and a current computational load of the device; and
replace the 2D plane representing the 3D virtual object with the 3D virtual object based on a combination of the current computational load of the device and a change in the user interaction level with the 2D plane representing the 3D virtual object.
